(19) United States
(12) Patent Application Publication
(10) Pub. No.: US 2007/0271798 A1
(43) Pub. Date: Nov. 29, 2007

(54) Brush cutting attachment for chainsaw bar

(76) Inventor: Jules Webb, Florien, LA (US)

Correspondence Address: Rodney B. Jordan, 700 North Nolan Trace, Florien, LA, 71429, US

(21) Appl. No.: 11/441,634

(22) Filed: May 26, 2006

(51) Int. Cl. B23D 51/02

(52) U.S. Cl. 30/371

(57) ABSTRACT

An attachment for a chainsaw cutting bar with fingers protruding beyond the cutting bar from a second bar mounted to the cutting bar for holding small limbs and brush in place while being cut.

### BACKGROUND OF THE INVENTION

There are few power tools that are as useful and effective as a chainsaw, however this widely used tool is designed primarily for cutting large tree trunks. To spite this the chainsaw is often used for other purposes, some of which it is ill suited for. One such purpose is the cutting and pruning of small trees, bushes, branches and briars. Using only the standard chainsaw bar the afore mentioned tasks are not only difficult but also dangerous. The elasticity of small branches and briers does not allow for the necessary rigidity required for clean and quick cutting. Often the chain will grab the material being cut, jerking the saw away from the operator. In addition, briars and small limbs can be violently pulled toward the operator. The present invention solves these problems by limiting the movement of such material with regard to the position of the chainsaw.

### DESCRIPTION OF THE PRIOR ART

There have been many innovations in the chainsaw bar area that have improved the safety effectiveness offered. Such things as chain brake mechanisms and specially designed cutter chain links have improved performance and safety however little has been done to improve the safety and effectiveness of the chainsaw when cutting briers, small limbs and small trees or using it in a swinging or overhead manner. The present invention has addressed this need in a positive way. The present invention is described in a provisional application filed on Jun. 27, 2005. The provisional application number is 60/595,366 by Jules Webb of 42, Webbwood Drive, Florien, La. 71429.

### BRIEF DESCRIPTION OF THE DRAWINGS

FIG. 1 is a side elevation view of the brush bar attachment.

FIG. 2 is a top elevation view of the brush bar attachment.

FIG. 3 is a side elevation view of a chainsaw with the brush bar attachment installed.

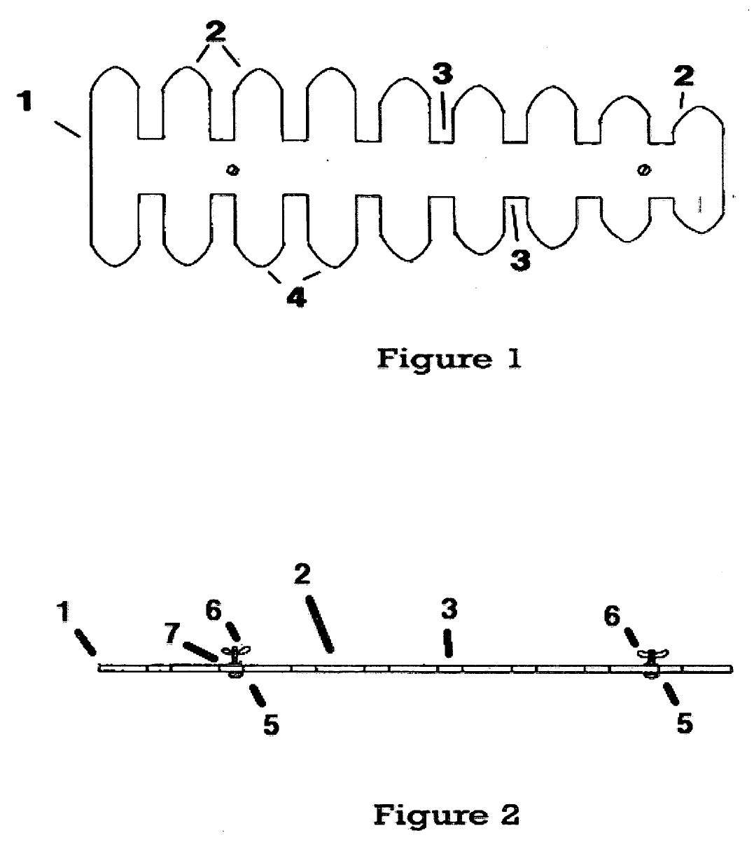

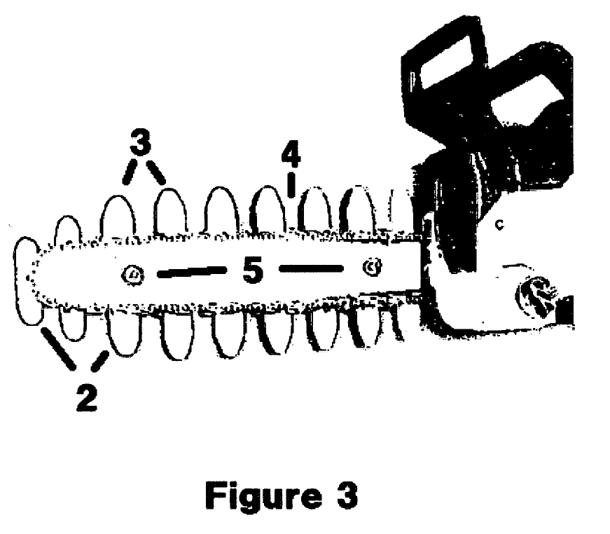

### DETAILED DESCRIPTION

Referring to the drawings it can be seen that a thin, flat, elongated mounting bar 1 is equipped with a plurality of fingers 2. These fingers 2 are each curved into a point at the ends 3. The fingers 2 are rowed down each side of the mounting bar 1. Each finger is adjacent to the other and spaced apart so as to leave a space 4 between the adjacent fingers. The apparatus is suitably sized so that when fastened to the side of a standard chainsaw cutting bar the mounting bar 1 will be narrower in width than the chainsaw cutting bar and each finger will protrude past the outer edges of the chainsaw cutting bar. As the chainsaw cutting bar is moved across small limbs, trees or briars, the material to be severed is forced by the pointed ends 3 of the fingers 2 into the spaces 4. The material is held there until severed by the chainsaw blade as it moved across them. Fingers 2 are perpendicular to and in the same plane with mounting bar 1. Fingers 2 may be slanted or angled away from perpendicular with regard to mounting bar 1 for certain applications. The mounting bar 1 is rigidly affixed to the chainsaw cutting bar by bolts 5 and wing nuts 6. Spacer washers 7 hold the mounting bar 1 and fingers 2 at a proper distance from the moving chainsaw blade so as to avoid contact and thus damage to the blade and fingers 2. Mounting bar 1 is affixed to the chainsaw cutting bar by bolts 5 as they traverse holes that are prepared in the chainsaw cutting bar and wing nuts 6.

I claim:

1. An apparatus for use in conjunction with a chainsaw to be attached to a chainsaw cutting bar for facilitating the cutting of flexible, moveable material comprising:
a. means for attaching said apparatus to said chainsaw bar,
b. means for holding said material in a stable position, and
c. means for directing said material into said position.

2. An apparatus as recited in claim 1, wherein said apparatus further comprises a mounting bar and a plurality of fingers protruding from and in the same plane with said mounting bar.

3. An apparatus as recited in claim 2, wherein said means for attaching said apparatus to said chainsaw bar comprises a plurality of bolt, spacer and nut combinations, said chainsaw cutting bar having a plurality of holes, said bolts traversing said spacers and said holes in said chainsaw cutting bar so as to engage said nuts, said spacers having a thickness, said thickness being sufficient to separate said apparatus from said chainsaw cutting bar.

4. An apparatus as recited in claim 1, wherein said means for holding said material in said suitable position comprises a plurality of fingers, said fingers being positioned parallel to one another, said fingers being separated so as to form spaces, said material being secured in said spaces between said fingers.

5. An apparatus as recited in claim 4, wherein said fingers are perpendicular with regard to said mounting bar.

6. An apparatus as recited in claim 4, wherein said fingers are slanted from said perpendicular position.

7. An apparatus as recited in claim 4, wherein said fingers have outer ends, said outer ends being formed into a point so as to direct said material into said spaces between said fingers as said chainsaw cutting bar is moved through said material.

8. An apparatus for use in conjunction with a chainsaw to be attached to a chainsaw cutting bar for facilitating the cutting of flexible, movable materials by a chainsaw cutting chain, said chainsaw cutting bar being flat, thin and elongated having a length, a width, an upper edge, a lower edge and a thickness said apparatus comprising a mounting bar, said mounting bar being flat, thin and elongated having a length, a width and a thickness, said length of said mounting bar being slightly longer than said cutting bar, said width of said mounting bar being slightly narrower than said cutting bar, said mounting bar being affixed to said cutting bar in a position parallel to, adjacent to and suitably separated from said cutting bar so as not to hamper the movement of said cutting chain as it moves around said cutting bar, said apparatus further comprising a plurality of fingers, said fingers being positioned parallel and within the same plane with one another, said fingers extending outward from said sides of said mounting bar, said fingers extending slightly past said upper and lower edges of said cutting bar, said fingers being suitably separated so as to form elongated spaces between said fingers so as to accommodate said flexible material being cut, said fingers having an inner end and an outer end and edges, said edges of said outer ends of said fingers being curved together so as to form a point, said point facilitating the entry of said flexible material into said spaces to be held for cutting by said cutting chain as said cutting bar is moved through said flexible material.
